(19) United States
(12) Patent Application Publication
(10) Pub. No.: US 2004/0059786 A1
(43) Pub. Date: Mar. 25, 2004

(54) Method for contact information verification and update

(76) Inventor: David A. Caughey, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/253,920

(22) Filed: Sep. 25, 2002

(51) Int. Cl. G06F 15/16

(52) U.S. Cl. 709/206

(57) ABSTRACT

A method is disclosed for contact information verification and update. An electronic mail message is send to a contact destination, for which contact information is stored within an electronic contact information database. Attached to the electronic message is a contact field displaying the contact information for said contact. A facility is provided, which allows the contact to modify the contact information. Optionally, a date is provided, when a modification of the current contact information being stored in the electronic contact information database becomes active. Further optionally, the attached contact information is obtained from an automatic can of the electronic contact information database. Also, a central e-mail server is possibly used to intercept an e-mail message at a central e-mail distribution station, and to modify the e-mail message other than changing routing information of the e-mail message.

### FIELD OF THE INVENTION

The present invention relates to electronic communication systems and more particularly to contact list management for use with electronic mail and messaging systems.

### BACKGROUND OF THE INVENTION

With the current advancements in communication technology, most people now have several methods by which they can be contacted. These methods include for example telephones, fax machines, electronic mail accounts, and pagers. With the increasing impact, importance, and popularity of electronic communication media, which is in a large part due to the success of the Internet, the electronic mail address has gained special importance amongst the contact addresses. Many electronic messaging systems keep electronic address books, which typically include contact information databases within which are stored records of the mailbox addresses for different users. It is often the case that these address books also store additional user information, such as telephone numbers, mailing addresses, job titles, and other information that is typically unrelated to electronic messaging.

As will be appreciated, the task of updating a list of numbers or addresses used to reach a desired individual can be time-consuming and susceptible to error. For example, area codes are often modified or people move from one location to another thereby rendering their old telephone number out of date. In many cases, address changes are recorded by a trial and error process. Some technologies, like electronic mail, produce an error message indicating that a message could not be delivered. In many cases this message does not refer to a new address that should be used instead. This then requires a manual update of an individual new contact address. However, considering the plethora of information that is often linked to an existing electronic mail contact, updating an electronic address book often provides a first and easy step in updating an individual's contact information.

In today's high-tech environment, new and evolving technologies are not only changing the way in which business is done, but also with whom business is done. It seems that the only constant factor in the modern business equation is change itself, which makes it important to keep personal and professional contact information up-to-date.

Although there are existing methods for automatically updating an electronic address book, the techniques used are limited. For example, services such as Internet-based address and contact information lists, as well as e-mail directory services are used to synchronize contact information of locally maintained address books with current contact information stored on a central storage system. However, vital contact information stored on a central server might suffer from accessibility problems in cases when the central server is experiencing network problems, or is being updated. Further, information stored on central server systems is vulnerable to security breaches and attacks.

One major problem often encountered with electronic address books is due to the fact that address changes are often noticed only after they have been effected—a letter is returned to the sender, a phone call only reaches an automatic answering services informing the caller that the number dialed is out of service, an e-mail bounces back since the recipient's address is no longer valid. The result is in many cases a loss of contact information, which requires individual attention to be restored. For people that entertain a large contact list, this is a serious waste of time, and unfortunately, such an update is often not performed. If such a loss is an occasional phenomenon, it is easily manageable, and depending on the importance of the contact lost, it is worthwhile to take the time to find the new contact information. Of course, there is a higher risk of potential loss of contact information with a larger number of contacts. Consequently, the time and expense involved in updating the contact list increases as the number of contacts increases.

In order to overcome such drawbacks of the prior art, it would be advantageous to provide users with a system, which arranges for the possibility to intermittently check the validity of contact information. It would be advantageous to incorporate such a check into the regular communication with contacts, whose information needs to be maintained and updated. It would be of further advantage to provide such a service in connection with electronic mail services and the Internet, both being on the verge of becoming the primary communication media of the future. In addition, it would be of advantage by employing distributed, peer-to-peer technologies, that contact information is always stored on an individual's local computer or server and never on the Web.

### OBJECT OF THE INVENTION

It is therefore the object of the present invention to provide in the context of electronic mail a method that on a regular basis validates and updates contact information.

### SUMMARY OF THE INVENTION

In accordance with an aspect of the instant invention, there is provided a method for contact information verification and update comprising the steps of sending at least an electronic mail message to a contact destination of at least one contact from a plurality of contacts, for which contact information is stored within an electronic contact information database, attaching a contact field to the at least an electronic mail message, the contact field displaying the contact information for said at least one contact, the contact information stored within the electronic contact information database, and allowing the at least one contact to modify the contact information, the contact information relating to said contact and being stored in the electronic contact information database.

In accordance with an aspect of the instant invention, there is further provided a method for contact information verification and update comprising the steps of sending at least an electronic mail message to a contact destination of at least one contact from a plurality of contacts, for which contact information is stored within an electronic contact information database, attaching a contact field to the at least an electronic mail message, the contact field displaying the contact information for said at least one contact, the contact information stored within the electronic contact information database, allowing the at least one contact to modify the contact information, the contact information relating to said contact and being stored in the electronic contact information database, and providing a date when a modification of the current contact information being stored in the electronic contact information database becomes active.

In accordance with another aspect of the instant invention there is provided a method for contact information verification and update comprising the steps of preparing an e-mail message for a destination by including a destination address and a body of the e-mail message, the destination address referring to an intended recipient of the e-mail message, searching a database for contact information relating to the destination address, retrieving the contact information form the database, when contact information relating to the destination address was found in the database, attaching to the e-mail message at a predetermined location thereof in an automatic fashion an indication of the intended recipient of the e-mail message and an indication of a request for contact information update therefrom, and transmitting the e-mail message to the destination address.

In accordance with yet another aspect of the instant invention there is provided a method for contact information verification and update comprising the steps of intercepting an email message at a central e-mail distribution station, modifying the e-mail message other than changing routing information of the e-mail message.

### BRIEF DESCRIPTION OF THE DRAWINGS

A preferred embodiment of the instant invention will be described in conjunction with the following drawings, in which:

FIG. 1 shows a schematic diagram of a general setup of an e-mail system supporting the method of the present invention;

FIG. 2 displays a prior art layout of an e-mail message;

FIG. 3 displays a layout of an e-mail message comprising a contact field;

FIG. 4 displays a layout of a contact field; and

FIG. 5 shows a flow diagram illustrating a procedure for verification and update of contact information.

### DETAILED DESCRIPTION OF THE INVENTION

As mentioned above, contacts are vital to a business. The present invention, which will now be described in detail, ensures that information, on which individuals and businesses depend, remains valid and accurate as persistent as possible, and especially at times when it is needed the most. An embodiment of the present invention will in the following be outlined in the context of electronic mail. However, a person of skill in the art will appreciate that the general ideas, on which the present invention is based, are not restricted to the field of electronic mail, but equally apply to other fields of communication and information exchange. Thus, the instant invention is not intended to be limited to the embodiment disclosed, but is to be accorded the widest scope consistent with the principles and features disclosed herein.

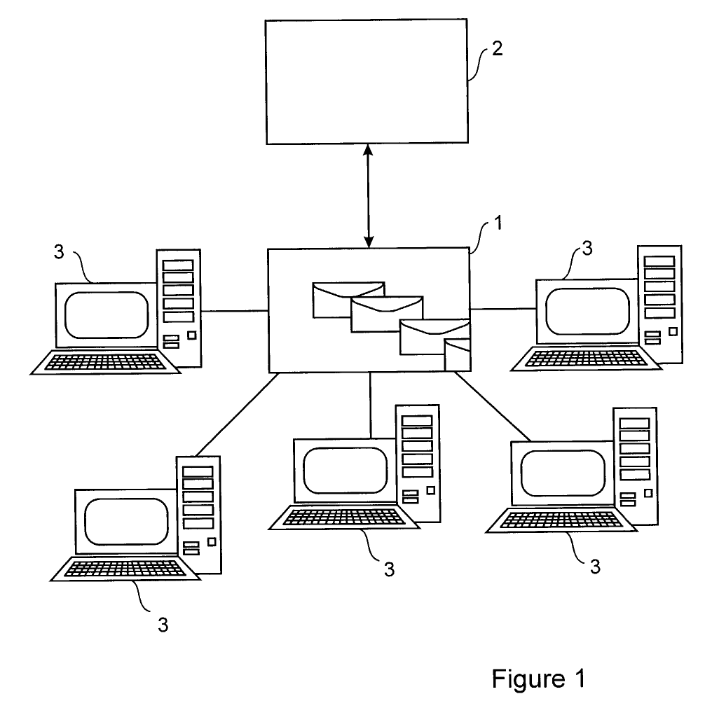

In FIG. 1, the basic architecture of a mail system supporting the present invention is outlined. The system comprises three important elements. A central mail server 1 manages a plurality of local e-mail accounts. The software running on the central mail servers supports the method according to the present invention. The software running on the central mail sever has further the possibility to analyze incoming mail regarding sender, e-mail subject lines, and the like. The central e-mail server is connected to a contact database 2. In the contact database 2 there is stored information regarding possible recipients of e-mail from the central mail server 1. The central mail server 1 services a plurality of individual user accounts 3, the individual user accounts being connected to the contact database 2 through the central mail server 1.

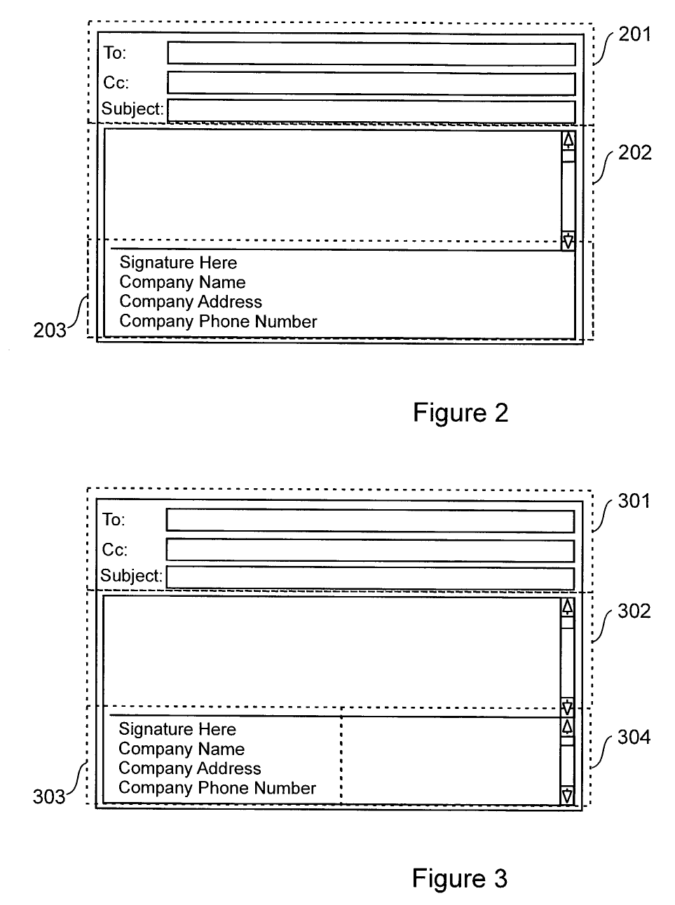

Referring now to FIG. 2, a basic outline of an electronic message, a so-called e-mail message, is presented. The electronic message is divided into different subsections as follows. The header of the e-mail 201 contains information regarding e-mail specifics such as an electronic address of the recipient as well as of the sender of the message, a subject line containing a summary line of the e-mail, and a date stamp indicating when the particular message was sent and received. Information regarding the sender and the recipient, as well as distribution specifics, is referred to as routing information. The general protocols used in electronic communication require specific formats and do not leave a user with much of a possibility for individual configuration of the header 201, the exception being the subject line. The main body of the e-mail 202 contains the information to be sent. A signature field 203 contains characteristic information about the sender, which is automatically attached to any message sent be an individual. The signature field provides an individual with a possibility to personalize a given e-mail message by adding relevant information, such as contact address, phone numbers, alternative electronic contact address, and the like. A common e-mail program allows a user to specify and predefine the information, which is going to be attached at the bottom of the e-mail message. Therefore, the signature is typically selected in connection with the sender of the e-mail. Alternatively, and not shown in FIG. 2, attachment files are included in the electronic mail message, which presence is indicated in certain attachment lines.

Automatically attaching a field, which is based not on information relating to the sender of an electronic message, but on information relating to the addressee of the e-mail message, provides a possibility to automatically validate and update contact information relating to a particular recipient. The appearance of such e-mail message is illustrated in FIG. 3. Again, the electronic mail message comprises a header section 301 as well as a main body of the message 302. At the end of the e-mail message, there is automatically attached a field containing contact information 304. The content of this field is based on information of the addressee, rather than on information of the sender of the e-mail message. Preferably, the information attached in field 304 is selected from the contact database 2, in which information of several contacts is stored. Further preferably, the selection of which entry of the database is going to be attached is based on the e-mail address of the recipient of the message. Optionally, a signature field 303 containing relevant information of the sender of the e-mail message is additionally attached to an outgoing e-mail message.

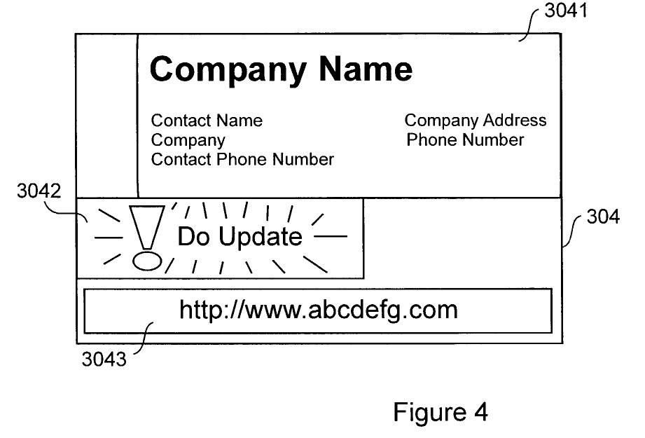

A more detailed composition of the automatically attached contact field 304 is presented in FIG. 4. The contact field 304 incorporates a snapshot of the business card information about a certain individual to be contacted, field 3041. In general, the contents of this field are identical to information stored in a databank of relevant contacts.

An attention/instruction field 3042 asks the recipient of an e-mail message for example to review the information presented in the contact field 304, and especially the information presented in field 3041, make sure that it is accurate, change it if it is wrong, add anything that is missing, and/or other relevant questions. The attention/instruction field 3042 is designed as to attract the attention of the recipient of the e-mail message to that particular field. The simplest way to do so is the use of appropriate punctuation marks, such as exclamation marks and question marks. Another way to attract attention is for example the use of unusual fonts, font sizes, font colors, and the like. Since many of the current programs used in retrieving and reading e-mail messages do incorporate certain internet mail capabilities such as simple mail transfer protocol (SMTP), and support hypertext mark-up language (HTML), the font changes are for example achieved by incorporating HTML 4 compliant <FONT> tags into the attention/instruction field 3042. Other methods such as Java™-based technologies using extensible mark-up language (XML) are possibly used within the attention/instruction field 3402. However, it is highly desirable to design an attention/instruction field 3402 as to be as compatible as possible with commonly used e-mail processing software. Whenever a new technology reaches a level of standardized general acceptance, the use of this new technology as possible attention getter is to be considered when designing the attention/instruction field 3402.

The update field 3403 provides the recipient with a link to a web-based interface for the contact database 2, in which his information is stored. The web-based interface allows the recipient of the e-mail message to update her or his contact information, such as address, phone number, electronic contact, internet addresses, and the like. Common SMTP-based mail programs provide the recipient of the e-mail with an http-link to be activated by mouse click. Other text based e-mail systems, such as elm or pine, typically display a uniform resource locator (URL), which has to be entered by the user into an Internet browser of her or his choice. When entering or updating contact information, there is optionally provided a data field indicating when the changes made in the contact data bases effectively take place. This way, an individual ensures that his or her contact information is updated when any change in contact information becomes active.

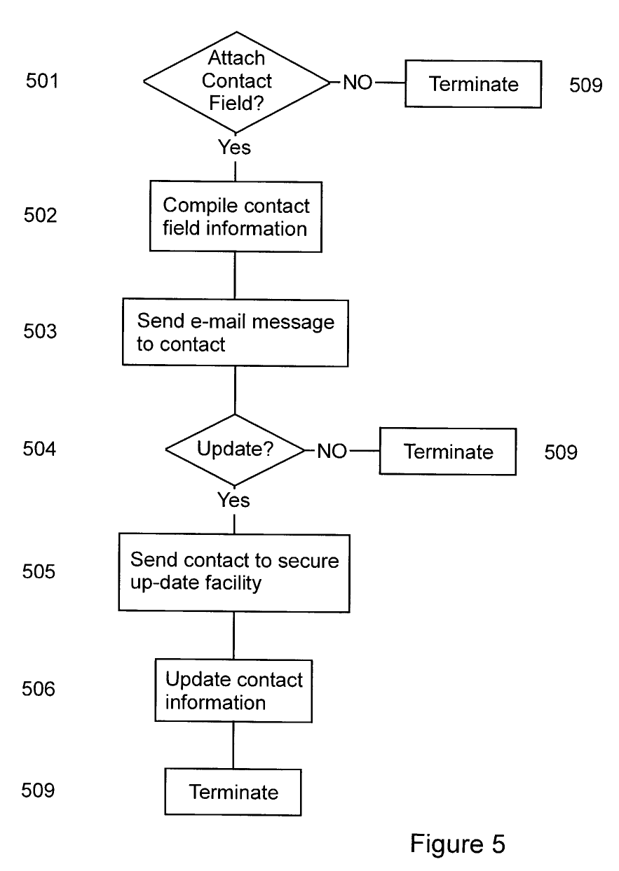

Referring now to FIG. 5, a flow diagram is shown illustrating a method according to a first embodiment of the present invention. In the flow chart, a procedure is outlined for verification and update of contact information. In a first step 501, it is decided whether a particular e-mail message is for receiving a contact field 304. Preferably, all messages created with an e-mail system supporting the method according to the first embodiment of the present invention receive a contact field by default. Alternatively, the question is decided by retrieving information from the contact database 2 containing information of possible recipients. If no contact field is going to be attached, the procedure for contact verification and update reaches termination, step 509. Once it is decided that a contact field is going to be attached, the information for the contact field 304 is compiled, step 502. Preferably, this information is retrieved form the contact database 2 containing information of possible recipients. If the addressee is a new contact, for whom no valid entry in the contact database 2 has been created, a generic message is displayed in the contact field 304, inviting the addressee to create an entry in the contact database 2. Preferably, the information retrieved from the contact database 2 is selected in reference to the addressee's e-mail address. It is typically a snapshot of current business card information of the addressee. Also, an update link is added to the contact field 304. Preferably, the update line refers to a web-based interface to the contact database 2 containing information of possible recipients. Further preferably, the web-based interface is initialized with the current information on file for an individual connecting to the web-based interface. Optionally, hidden sections are added to the contact field, which are used for example to store information relevant for identifying the sender of a message. This information is possibly used in further steps of the procedure.

A physical location of a server providing the web-based interface is self-contained, and is independent from a physical location of the central e-mail server 1 and the contact database 2. Although the central e-mail server 1 is optionally used to host the web-based interface, this is not a necessity of the present invention. Any independent server suffices to provide the web-based interface, which will independently transfer the received information to the contact database 2.

The e-mail message is send to the contact, step 503. Depending on the choice of the contact, the information in the contact database 2 is either updated or left unchanged, step 504. If the recipient decides not to update, the procedure for contact verification and update reaches termination, step 509. If the recipient decides to update, he triggers by activating the appropriate link in the contact field 304 the connection to the web-based interface. The recipient is sent to a secure web-form, where he or she can enter the new data and update the contact information, step 505.

Once the recipient has entered her or his changes, the contact database 2 containing information of possible recipients needs to be updated, step 506. For example, changes made by the recipient are packaged into an electronic message and are forwarded to the sender of the message. In this case, the web-interface serves as a provider for a web-form only. Information regarding a target e-mail, to which the updated information is to be sent, is optionally passed to the web-form by means of hidden form entries, utilizing information stored in the hidden sections of the contact field. This way, the contact database 2 storing information regarding possible recipients is not exposed on the net, which often introduces another element of data insecurity. The web-based interface optionally creates a sensitive subject line in the e-mail containing the information entered into the web-form. The central e-mail server 1 receiving the e-mail message recognizes the subject line, and enters a procedure to update the database 2 containing information regarding possible recipients, based on the information provided in that e-mail message. Alternatively, the web-based interface directly communicates with the contact database 2 containing information about possible recipients.

Once a response is received and processed, and the contact database 2 including a web address book is automatically updated, the procedure reaches termination, step 509. Optionally, after successfully performing an update of an entry in the contact database 2, the corresponding contact is informed about the successful update be sending an e-mail message, which shows his new contact information.

In another embodiment of the present invention, a date is provided as to when changes regarding contact information, the changes entered into the web-based interface, are actually becoming active. The attention/instruction field 3042 informs the recipient of the possibility to update an address change in advance. The web-form provided by the web-based interface provides an entry field for a date as to when a certain entry will become active. This way, it is possible to keep contact information as currently updated as possible.

The present invention allows its user to keep in touch with every contact contained within a contact list, regardless of changes in the corresponding electronic contact address. It is optionally used in cooperation with other techniques such as automatically updating electronic mailing lists, distributing Keep-in-Touch messages, and the like. The present invention further allows the contact to keep a certain amount of anonymity. The contact her- or himself has full control about which contact information he or she is willing to release, and about the amount of contact information he or she is willing to release.

The principle of contact information verification and update also applies to the attached signature files. By automatically attaching an up-to-date signature file, the recipient of an e-mail message is able to update and verify the contact information of the sender of the e-mail message. Alternatively, all e-mail messages sent by individuals being part of a group of people, like employees of a company, are automatically tagged with a signature containing information about the company. A central mail server of the company intercepts all outgoing e-mail messages and modifies the body of the e-mail message by attaching tag. The attached tag contains specific information, as for example a company-specific signature information, or the request for an update of contact information. Optionally, the e-mail messages are intercepted at a central email distribution station. This way, all employees of a company represent the company in a consistent way in their e-mail messages.

Another embodiment of the instant invention relates to the use of contact field information in connection with a support center environment, and especially in connection with support services offered over the Internet, as for example product support services, and the like. A person of skill in the art will appreciate that these ideas are possibly extended to include chat services, phone support services, and other support services. For example, a costumer purchasing a product is provided with a contact e-mail address, which is used to contact the manufacturer's support service in case complications arise with the purchased product. Alternatively, a customer of a certain product is provided with an e-mail address used for registration of the purchased product. The customer contacts the manufacturer for support or registration purposes. Typically, the customer is a first time contacting customer. E-mails received at the manufacturer's site, which relate to a certain product or support request, are collected, and are used to set up a first time costumer contact database. In the initial stage, only the e-mail address of a given costumer is known, constituting a single piece of contact information. Then, a reply e-mail is created, the reply e-mail including a contact filed. The customer is asked to provide additional contact information. The customer is for example asked to provide an e-mail reply containing updated contact information such as address and telephone number, or to visit a web based contact interface to update his or her contact information. This way, the database of customers of a given product, or of users of a given support service, is constantly extended as well as updated. This strategy is easily applied to other services, in which an initially unknown customer contacts for a first time a support center, using electronic mail, or any other Internet based service.

Although the present invention has been described with respect to a specific embodiment thereof, various changes and modifications are optionally carried out by those skilled in the art without departing from the scope of the invention. Therefore, it is intended that the instant invention encompass such changes and modifications as fall within the scope of the appended claims.

What is claimed is:

1. A method for contact information verification and update comprising the steps of:
sending at least an electronic mail message to a contact destination of at least one contact from a plurality of contacts, for which contact information is stored within an electronic contact information database;
attaching a contact field to the at least an electronic mail message, the contact field displaying the contact information for said at least one contact, the contact information stored within the electronic contact information database; and
allowing the at least one contact to modify the contact information, the contact information relating to said contact and being stored in the electronic contact information database.

2. A method for contact information verification and update according to claim 1, wherein the at least an electronic mail message is sent using an electronic mail application.

3. A method for contact information verification and update according to claim 1, wherein a web-based interface is used in modifying the contact information stored within an electronic contact information database.

4. A method for contact information verification and update according to claim 3, wherein the web-based interface is connected to the electronic contact information database for modifying contact information stored with the electronic contact information database.

5. A method for contact information verification and update according to claim 3, wherein the web-based interface delivers modified contact information to a central e-mail server in contact with the electronic contact information database by sending an electronic mail message.

6. A method for contact information verification and update according to claim 1, wherein the electronic mail message is sent by a support center in response to an electronic mail request received from a first time contacting customer.

7. A method for contact information verification and update according to claim 6, wherein electronic mail requests of first time contacting customers constitute a first time customer contact database, the database updated by the first time contacting customers in response to the electronic mail message comprising a contact field.

8. A method for contact information verification and update according to claim 1, further comprising the step of informing the at least one contact about a modification of contact information stored within an electronic contact database by sending at least an electronic message comprising the modification of contact information to said at least one contact.

9. A method for contact information verification and update comprising the steps of:
sending at least an electronic mail message to a contact destination of at least one contact from a plurality of contacts, for which contact information is stored within an electronic contact information database;
attaching a contact field to the at least an electronic mail message, the contact field displaying the contact information for said at least one contact, the contact information stored within the electronic contact information database;
allowing the at least one contact to modify the contact information, the contact information relating to said contact and being stored in the electronic contact information database; and
providing a date when a modification of the current contact information being stored in the electronic contact information database becomes active.

10. A method for contact information verification and update according to claim 9, wherein the at least an electronic mail message is sent using an electronic mail application.

11. A method for contact information verification and update according to claim 9, wherein a web-based interface is used in modifying the contact information stored within an electronic contact information database.

12. A method for contact information verification and update according to claim 11, wherein the web-based interface is connected to the electronic contact information database for modifying contact information stored with the electronic contact information database.

13. A method for contact information verification and update according to claim 11, wherein the web-based interface delivers modified contact information to a central e-mail server in contact with the electronic contact information database by sending an electronic mail message.

14. A method for contact information verification and update according to claim 9, further comprising the step of informing the at least one contact about a modification of contact information stored within an electronic contact database by sending at least an electronic message comprising the modification of contact information to said at least one contact.

15. A method for contact information verification and update comprising the steps of:
preparing an e-mail message for a destination by including a destination address and a body of the e-mail message, the destination address referring to an intended recipient of the email message;
searching a database for contact information relating to the destination address;
retrieving the contact information form the database, when contact information relating to the destination address was found in the database;
attaching to the e-mail message at a predetermined location thereof in an automatic fashion an indication of the intended recipient of the e-mail message and an indication of a request for contact information update therefrom;
transmitting the e-mail message to the destination address.

16. A method for contact information verification and update according to claim 15, wherein the indication of a request for contact information includes a reference to the database.

17. A method for contact information verification and update according to claim 16, wherein the recipient of the e-mail message updates the information stored within the database.

18. A method for contact information verification and update according to claim 16, wherein the reference to the database is made through an electronic e-mail address.

19. A method for contact information verification and update according to claim 16, wherein the reference to the database is made through a web-based interface.

20. A method for contact information verification and update comprising the steps of:
intercepting an e-mail message at a central e-mail distribution station;
modifying the e-mail message other than changing routing information of the e-mail message.

21. A method for contact information verification and update according to claim 20, wherein the e-mail message is modified by attaching a tag, the tag containing information specific to the e-mail distribution station.

22. A method for contact information verification and update according to claim 20, wherein the e-mail message is modified by attaching a tag, the tag containing information requesting from a recipient of the e-mail message an information update.

23. A method for contact information verification and update according to claim 20, wherein the e-mail message is modified by attaching a tag, the tag containing information retrieved from a data base accessible to the central e-mail distribution station.

24. A method for contact information verification and update according to claim 23, wherein data retrieval from the database occurs according to routing information of the e-mail message.
